(19) United States
(12) Patent Application Publication
(10) Pub. No.: US 2005/0198761 A1
(43) Pub. Date: Sep. 15, 2005

(54) Rear wiper bracket assembly

(76) Inventors: Taurris D. Baskerville, Algonquin, IL (US); Michael E. Ward, Geneva, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/038,961

(22) Filed: Jan. 20, 2005

Related U.S. Application Data
(60) Provisional application No. 60/552,303, filed on Mar. 11, 2004.

(51) Int. Cl. B60S 1/32

(52) U.S. Cl. 15/250.19

(57) ABSTRACT

A windshield wiper bracket assembly for mounting on a motor vehicle panel includes a bracket adapted to mount on one side of the panel and a threaded fastener extending through the panel, with an arm for engaging an opposite side of the panel. The threaded fastener is received in a hole of the bracket for securing the bracket while sandwiching a portion of the panel between the bracket and the arm.

### CROSS-REFERENCE TO RELATED APPLICATIONS

The present regular U.S. patent application claims the benefits of U.S. Provisional Application Ser. No. 60/552,303 filed Mar. 11, 2004.

### FIELD OF THE INVENTION

The present invention relates generally to assemblies, such as brackets, that are mounted on an object through an opening in the object; and, more particularly, to rear wiper arm support bracket assemblies mounted through openings in body panels of automobiles.

### BACKGROUND OF THE INVENTION

Sport utility vehicles and other automobiles often provide a wiper arm on the rear window for clearing rain, snow and other moisture from the outer surface of the window. It is known to provide a support in the form of a bracket spaced some distance from the pivoting end of the wiper arm, so that the wiper arm has a support from underneath when the wiper is in an off or inactive state. The bracket is secured to the outer panel or tailgate of a sports utility vehicle or other vehicle.

It is known to secure rear wiper brackets by means of a riveting nut and threaded fastener whereby the riveting nut is inserted in an opening of the body panel, and expanded to engage the panel at the opening. The bracket is secured to the riveting nut using a threaded fastener. In a known assembly process, the riveting nut is first attached to a tailgate panel by way of a riveting nut gun. Thereafter, the bracket, which may be of rubber, is positioned on the outside of the tailgate or other vehicle panel, and a screw is passed through the rubber bracket and threaded into the riveting nut to secure the rubber bracket to the tailgate. A driver of suitable type is used to tighten the screw in the nut. This known assembly process requires two steps, first securing the riveting nut to the panel, and second securing the bracket to the riveting nut. Two tools are required, a riveting nut gun for securing the nut in position, and an appropriate driver for turning the screw.

Although this known assembly for a rear wiper bracket support has proven to be satisfactory once assembled and ready for use, installation is somewhat cumbersome and time consuming. The assembly includes three individual parts, the riveting nut, the bracket and the screw to complete the assembly. As a result, assembly is somewhat awkward. Moreover, because three individual parts are required, separate inventories of each are needed and the individual parts must be gathered for completing an installation. This adds to the complexity of inventory control and vehicle assembly.

There is a need to improve rear wiper bracket assemblies to facilitate installation and to simplify parts inventory control in automobile manufacturing plants.

### SUMMARY OF THE INVENTION

The present invention provides a rear wiper bracket assembly with two components that can be pre-assembled prior to installation on the vehicle.

In one aspect thereof, the present invention provides a bracket assembly for attachment to a panel having an opening therein extending between a first side and a second side of the panel. The bracket assembly has a bracket on one side of the panel. The bracket defines a hole. A threaded fastener has a shaft inserted through the opening. The shaft has a thread thereon for threaded engagement in the hole, and an arm extending laterally from the shaft for engaging an opposite side of the panel sandwiched between the arm and the bracket.

In another aspect thereof, the present invention provides an assembly to be attached to an object having an opening extending between first and second sides of the object. The assembly has a body defining a hole. The body is configured for positioning on the first side of the object. A threaded fastener has a threaded shaft for threaded engagement in the hole, and an arm projecting laterally from the shaft for engaging the second side of the object, with the fastener positioned in the opening and a portion of the object being sandwiched between the arm and the body.

In a further aspect thereof, the present invention provides a windshield wiper bracket assembly for mounting on a vehicle panel having an opening between a first side of the panel and a second side of the panel. The windshield wiper bracket assembly has a bracket configured for supporting a wiper arm. The bracket defines a hole and is configured for positioning on one side of the panel. A threaded fastener has a threaded shaft for threaded engagement in the hole, and an arm extending laterally from the shaft. The arm is configured for engaging an opposite side of the panel from the side on which the bracket is positioned, with the threaded fastener extending through the opening in the panel.

An advantage of the present invention is providing a rear wiper bracket assembly that can be pre-assembled and installed with a simple procedure.

Another advantage of the present invention is reducing the number of component parts required for a rear wiper bracket assembly in automobile assembly plants.

Still another advantage of the present invention is providing an object that can be secured to a panel in a fast, efficient manner.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an cross-sectional view of a rear wiper bracket assembly in accordance with the present invention, illustrating the assembly installed on a panel of a vehicle;

FIG. 2 is a cross-sectional view similar to FIG. 1, but illustrating the bracket assembly at an early stage of installation;

FIG. 3 is a perspective view of the bracket portion of a bracket assembly of the present invention; and

FIG. 4 is cross-sectional view of a second embodiment for a bracket assembly of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

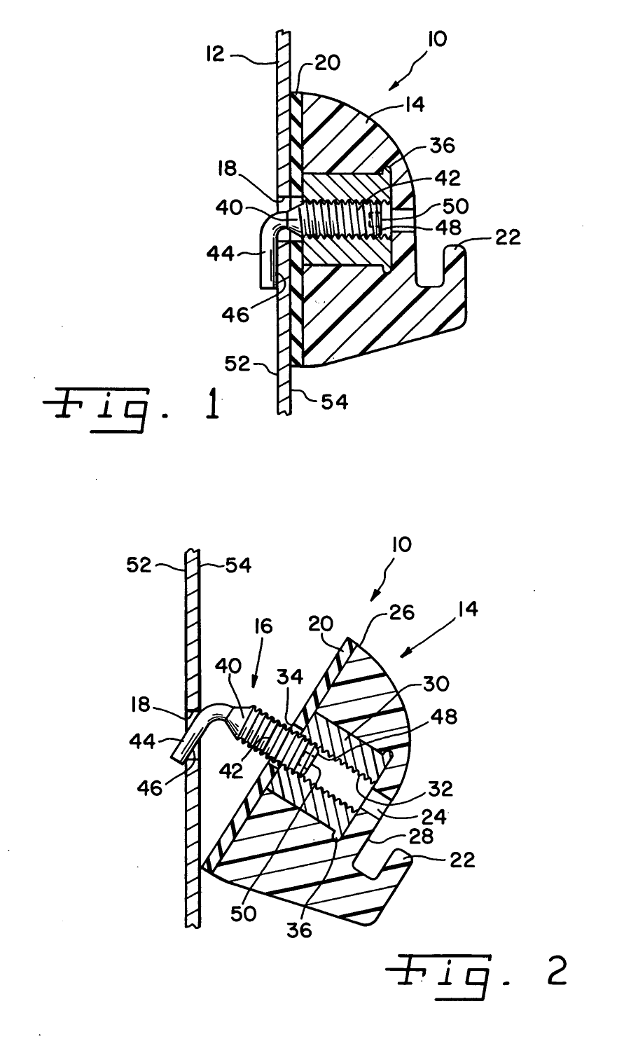

Referring now more specifically to the drawings and to FIG. 1 in particular, numeral 10 designates a rear wiper bracket assembly in accordance with the present invention. Bracket assembly 10 is illustrated mounted on a panel 12 which may be, for example, an outer panel of a rear door of a vehicle or the like. While the present invention is illustrated as and has particular use for mounting a wiper arm support bracket for a rear wiper on an automobile such as a sports utility vehicle or the like, features of the present invention can be incorporated into mounting assemblies for mounting other assemblies on other objects.

Bracket assembly 10 includes a bracket 14 and a threaded fastener 16 for securing bracket assembly 10 through an opening 18 in panel 12. A gasket 20 is disposed between bracket 14 and panel 12 to provide a weather-tight seal so that moisture and other contaminants do not migrate through opening 18.

Bracket 14 is the support body on which a rear wiper arm (not shown) of a vehicle can rest. To that end, bracket 14 defines a lip 22 for engaging the wiper arm (not shown). The general outer configuration of bracket 14 and lip 22 can be changed for aesthetic and/or functional purposes.

Bracket 14 defines a hole 24 therethrough, which extends from a first side 26 of bracket 14 nearest panel 12 to a second or exposed side 28 of bracket 14. Hole 24 defines an enlarged cavity in which a female threaded fastener 30 is disposed. Female threaded fastener 30 includes female threads 32 substantially axially aligned with hole 24 and with a hole 34 in gasket 20.

Bracket 14 and female threaded fastener 30 can be made of metal, plastic or other suitable material, and need not be of the same material. For example, bracket 14 can be rubber, and female threaded fastener can be metal. Female threaded fastener 30 is embedded in bracket 14 and held therein by adhesive or other bonding agent, by casting or forming bracket 14 around female threaded fastener 30, by interference fit of female threaded fastener 30 in bracket 14, or by other suitable means. Female threaded fastener 30 can include a ridge 36 or other configuration for securing female threaded fastener 30 within bracket 14 such that female threaded fastener 30 is held non-rotatably in bracket 14.

Threaded fastener 16 likewise can be of metal, plastic or other material suitable for the application and use of assembly 10. Fastener 16 includes a shaft 40 having male threads 42 thereon configured for threadedly engaging female threads 32. An arm 44 projects laterally from an end of shaft 40 and is of sufficient length to exceed the diameter of opening 18. While arm 44 can be configured from substantially round stock, a surface 46 thereof for engaging panel 12 in one embodiment is flattened for seating tightly against panel 12. At an end of shaft 40 opposite arm 44 a tip 48 of shaft 40 within hole 24 in the assembled bracket assembly 10 is configured for engaging a tool inserted through hole 24 to rotate and drive threaded fastener 16 in female threaded fastener 30. In one embodiment, tip 48 defines an orifice 50 for receiving a hexdrive tool, screwdriver bit or other male drive component to be inserted in orifice 50. Other female or male drive configurations for engaging a tool inserted through hole 24 also can be used.

In use, bracket assembly 10 can be shipped in pre-assembled form as illustrated in FIG. 2, with threaded fastener 16 partially inserted into bracket 14. When installation on a vehicle is performed, only one pre-aasembled component need be acquired. In the pre-assembled form, only a limited length of the distal end of male threads 42 are engaged with female threads 32 so that a substantial distance is provided between arm 44 and the panel engaging surface of gasket 20. As illustrated in FIG. 2, bracket assembly 10 is tilted such that arm 44 can be inserted angularly through opening 18. Tilting the most distant edge of bracket assembly 10 toward panel 16 aligns threaded fastener 16 within opening 18.

A tool (not shown) is inserted through hole 24 and drivingly engaged with tip 48 of threaded fastener 16. In the exemplary embodiment, the tool (not shown) is inserted in orifice 50. Fastener 16 is rotated so that male threads 42 advance along female threads 32, drawing arm 44 toward bracket 14. In this manner, threaded fastener 16 is drawn into bracket 14 until arm 44 engages an inner surface 52 of panel 12, and gasket 20 is compressed between bracket 14 and an outer surface 54 of panel 12. Bracket 14 is thereby held securely in its operative position relative to panel 12 with the assembly thereof onto panel 12, requiring only one simple operation and one tool for driving threaded fastener 16.

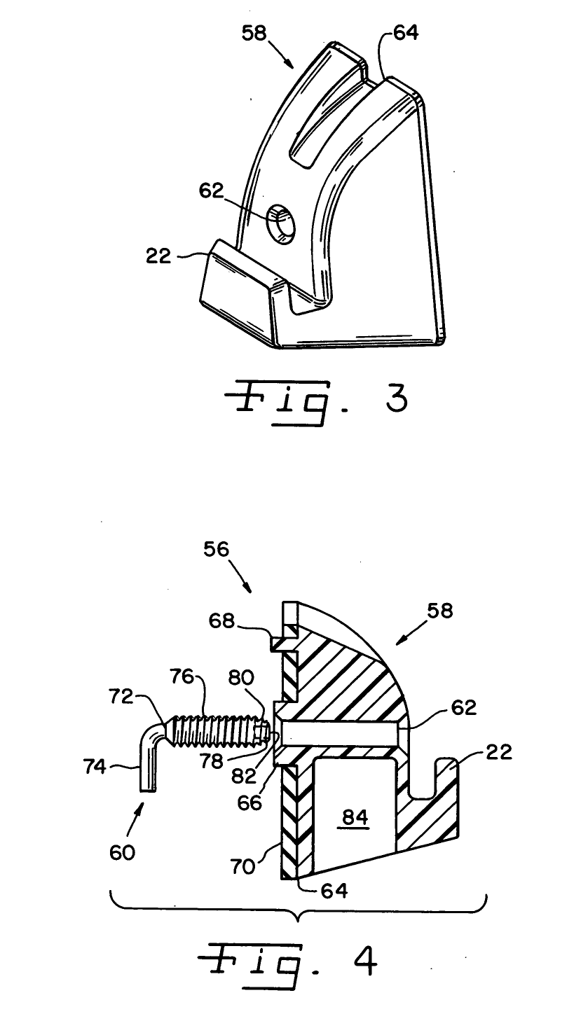

FIGS. 3 and 4 illustrate a second embodiment of the present invention. Bracket assembly 56 includes a bracket 58 and a threaded fastener 60. Bracket 58 is injection molded ABS plastic or the like and defines a hole 62 extending therethrough. On a panel side 64 thereof, bracket 58 defines a boss 66 around the end of hole 62 and may further define one or more posts 68. In a second molding process, a rubber gasket 70 is molded against panel side 64 and around boss 66 and the one or more posts 68. Gasket 70 can be provided flush with the outer ends of boss 66 and posts 68, or boss 66 and posts 68 can project slightly beyond gasket 70, as shown, to be received in opening 18 of panel 12 and other suitable holes or openings in panel 12 for receiving posts 68. With boss 66 and one or more posts 68 projecting slightly into panel 12, precise positioning of bracket 58 can be achieved relative to panel 12.

Threaded fastener 60 is similar to threaded fastener 16, including a shaft 72 and an arm 74 extending laterally from one end of shaft 72. Shaft 72 has male threads 76 that are self-tapping, with entrance threads 78 provided on a tapered tip 80 of fastener 60. No threads are required in hole 62, with self-tapping threads 76 of threaded fastener 60 cutting a path into the wall forming hole 62 as threaded fastener 60 is drawn into bracket 58. An orifice 82 is provided in tapered tip 80 and is similar to orifice 50 for engaging a drive tool to rotate threaded fastener 60.

In the embodiments illustrated, threaded fastener 16 and threaded fastener 60 can be driven from the outside of brackets 14 or 58, with a tool inserted into holes 24 or 62. Male threads 42 and female threads 32 in bracket assembly 10, or self-tapping male threads 76 in bracket assembly 56 can be provided as left-hand threads so that, when driven from the outer side of bracket 14 or bracket 58, a more conventional clock-wise rotation can be used to draw threaded fastener 16 into bracket 14, or threaded fastener 60 into bracket 58. However, right-hand threads and counterclock-wise rotation also can be used. Bracket assembly 10 is illustrated with right hand threads, and bracket assembly 56 is illustrated with left-hand threads; however, either assembly can use right-hand or left-hand threads.

It should be further understood that threaded fastener 16 or threaded fastener 60 can be driven by rotating arms 44 and 74. If assembly permits access behind panel 12 sufficient for rotating fasteners 16 or 60 from the end having arms 44 or 74, holes 24 or 62 need not extend completely through brackets 14 or 58. A closed outer surface is then provided for brackets 14 or 58, further inhibiting the ingress of moisture, dirt or other contaminants. The smooth, closed, outer surface also may provide aesthetic appeal.

As those skilled in the art will understand readily, brackets 14 and 58 can be provided with voids or cavities 84, to reduce material requirements for and weight of the brackets.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A bracket assembly for attachment to a panel having an opening therein extending between a first side and a second side of the panel, said bracket assembly comprising:
a bracket on one side of the panel, said bracket defining a hole; and
a threaded fastener having a shaft inserted through the opening, said shaft having a thread thereon for threaded engagement in said hole, and an arm extending laterally from said shaft for engaging an opposite side of the panel sandwiched between said arm and said bracket.

2. The bracket assembly of claim 1, said threaded fastener having a self-tapping thread.

3. The bracket assembly of claim 2, said hole extending through said bracket from one side thereof to an opposite side thereof and said shaft having an end in said hole adapted to be driven by a tool inserted into said hole.

4. The bracket assembly of claim 3, said end having an orifice for receiving the tool.

5. The bracket assembly of claim 3, including a gasket between said bracket and the panel.

6. The bracket assembly of claim 1, including a female threaded component disposed in said bracket and said threaded fastener engaging said female threaded component.

7. The bracket assembly of claim 6, said hole extending through said bracket from one side thereof to an opposite side thereof, and said shaft having an end in said hole adapted to be driven by a tool inserted into said hole.

8. The bracket assembly of claim 7, said end having an orifice for receiving the tool.

9. The bracket assembly of claim 1, including a gasket between said bracket and the panel.

10. An assembly to be attached to an object having an opening extending therethrough between first and second sides of the object, said assembly comprising:
a body defining a hole, said body configured for positioning on the first side of the object;
a threaded fastener having a threaded shaft for threaded engagement in said hole, and an arm projecting laterally from said shaft for engaging the second side of the object, with said fastener positioned in the opening and a portion of the object being sandwiched between said arm and said body.

11. The assembly of claim 10, said body having a female threaded component embedded therein, said female threaded component defining at least a part of said hole.

12. The assembly of claim 10, including a gasket between said body and the object.

13. The bracket assembly of claim 10, said hole extending from one side of said body to an opposite side of said body and being configured for receiving a tool to drive said fastener.

14. The assembly of claim 13, said shaft having an end in said hole with an orifice in said end for receiving a tool.

15. The assembly of claim 10, said threaded fastener having a self-tapping thread.

16. A windshield wiper bracket assembly for mounting on a vehicle panel having an opening between a first side of the panel and a second side of the panel, said windshield wiper bracket assembly comprising:
a bracket configured for supporting a wiper arm, said bracket defining a hole and being configured for positioning on one side of the panel; and
a threaded fastener having a threaded shaft for threaded engagement in said hole and an arm extending laterally from said shaft, said arm configured for engaging an opposite side of the panel from the side on which the bracket is positioned, with said threaded fastener extending through the opening in the panel.

17. The windshield wiper bracket assembly of claim 16, an end of said shaft in said hole having a tip configured for engaging a tool to rotate said fastener.

18. The windshield wiper bracket assembly of claim 17, said tip defining an orifice for engaging the tool.

19. The windshield wiper bracket assembly of claim 16, including a gasket between said bracket and the panel.

20. The windshield wiper bracket assembly of claim 19,said gasket being attached to said bracket.

21. The windshield wiper bracket assembly of claim 16, said bracket defining a boss at an end of said hole, said boss configured for insertion into the opening in the panel.

22. The windshield wiper bracket assembly of claim 16, including a female threaded fastener disposed in said bracket, and said threaded shaft engaging said female threaded fastener.

23. The windshield wiper bracket assembly of claim 16, said threaded shaft having a self-tapping thread.
